(19) United States
(12) Patent Application Publication
(10) Pub. No.: US 2011/0316443 A1
(43) Pub. Date: Dec. 29, 2011

(54) ILLUMINATING APPARATUS AND ILLUMINATING METHOD THEREOF

(75) Inventors: Jwo-Huei Jou, Taipei (TW); Hsi-Ching Wang, Hsin-Chu (TW)

(73) Assignee: NATIONAL TSING HUA UNIVERSITY, Hsin-Chu City (TW)

(21) Appl. No.: 12/967,363

(22) Filed: Dec. 14, 2010

(30) Foreign Application Priority Data
Jun. 29, 2010 (TW) 099121324

(51) Int. Cl. H05B 37/02

(52) U.S. Cl. 315/294

(57) ABSTRACT

The present invention discloses an illuminating apparatus and an illuminating method thereof. The illuminating apparatus comprises a first electrode, a first organic light emitting diode, a second electrode, a second organic light emitting diode and a third electrode. The first and second organic light emitting diodes emit lights with a first chromaticity and a second chromaticity respectively. The illuminating apparatus further comprises a control module, and the control module can supply a first voltage, a second voltage and a third voltage to the first, second and third electrodes so as to emit a sun-like light and adjust the color temperature or the brightness of the light.

### FIELD

The exemplary embodiment(s) of the present invention relates to a field of illuminating apparatus and an illuminating method thereof. More specifically, the exemplary embodiment(s) of the present invention relates to an illuminating apparatus and illuminating method thereof of a stack organic light emitting diode.

### BACKGROUND

The conventional light emitting diode (LED) is electricity-saving, however, the conventional LED is point light source, and has a plurality of disadvantages such as concentrating light spot and harsh to the human eye. The organic light emitting diode (OLED) is a plane light source, and can emit an imitative natural light without generating high heat and the light is soft.

Besides, the cold light characteristic of the OLED could effectively solve the heat dissipating problem of using the LED as an illuminating light source. Therefore, the OLED will rewrite the illuminating history of human being, and could be a significant help during the winter or to the regions lacked sunshine such as north Europe. With the illuminating techniques of the OLED broadly applied to the indoor lighting, the market share of OLED will achieve to 25% in 15-20 years, so does further decrease about 7 million tons of greenhouse gases.

However, the conventional OLED lamps could only illuminate light with single color temperature, thus only the feelings of daytime and cloudy day could be presented in-door, and the OLED lamps could not illuminate light with the feelings of blue sky or sunset time. Therefore, it seems important providing an OLED lamp to improve the monotone and gray in-door lighting technology.

### SUMMARY

To solve the problems in the conventional arts, it is a primary object of the present invention to provide an illuminating apparatus and an illuminating method thereof to solve the problem that the conventional OLED could only emit lights with one color temperature.

To achieve the above object, an illuminating apparatus according to the present invention is disclosed, which comprises a first electrode, a first organic light emitting diode, a second electrode, a second organic light emitting diode and a third electrode. The first organic light emitting diode is disposed on the first electrode and emitting lights with a first chromaticity; The second electrode is disposed on the first organic light emitting diode; The second organic light emitting diode is disposed on the second electrode and emitting lights with a second chromaticity; The third electrode is disposed on the second organic light emitting diode. The first electrode has a first voltage, the second electrode has a second voltage and the third electrode has a third voltage so the illuminating apparatus emits an imitative natural light. The chromaticity of the imitative natural light is matched with a sun-light trajectory on a color coordinate by adjusting a plurality of voltage difference between the first voltage, the second voltage and the third voltage.

Wherein, the illuminating apparatus further comprises a control module, and the control module is electrically connected to the first electrode, the second electrode and the third electrode, and can supply the first voltage, the second voltage and the third voltage to the first, second and third electrodes respectively, so as to control illuminating apparatus to emit the imitative natural light and adjust the color temperature, the brightness of the imitative natural light.

Wherein, the first organic light emitting diode and the second organic light emitting diode is a fluorescent material or a phosphorescence material.

Wherein, the first chromaticity and the second chromaticity comprises red light, blue light, green light, orange light, yellow light or white light.

Wherein, the plurality of voltage difference comprises a first voltage difference and a second voltage difference. The first voltage difference is the difference between the first voltage and the second voltage, and the second voltage difference is the difference between the second voltage and the third voltage. when the difference between the position of the imitative natural light on the color coordinate and the position of the first chromaticity on the color coordinate is smaller than the difference between the position of the imitative natural light on the color coordinate and the position of the second chromaticity on the color coordinate, the control module sets the first voltage difference larger than the second voltage difference.

Wherein, when the difference between the position of the imitative natural light on the color coordinate and the position of the first chromaticity on the color coordinate is larger than the difference between the position of the imitative natural light on the color coordinate and the position of the second chromaticity on the color coordinate, the control module sets the first voltage difference smaller than the second voltage difference.

Wherein, when the difference between the position of the imitative natural light on the color coordinate and the position of the first chromaticity on the color coordinate is equal to the difference between the position of the imitative natural light on the color coordinate and the position of the second chromaticity on the color coordinate, the control module sets the first voltage difference equal to the second voltage difference.

To achieve another object, an illuminating method according to the present invention is disclosed, which is applicable to an illuminating apparatus. The illuminating apparatus comprises at least a first electrode, a first organic light emitting diode, a second electrode, a second organic light emitting diode and a third electrode. The illuminating method comprises the following steps of: giving the first electrode a first voltage; giving the second electrode a second voltage, so the first organic light emitting diode emitting light according to a first chromaticity; giving the third electrode a third voltage, so the second organic light emitting diode emitting light according to a second chromaticity; and emitting an imitative natural light by the illuminating apparatus and adjusting the color temperature or the brightness of the imitative natural light at same time by adjusting a plurality of voltage difference between the first voltage, the second voltage and the third voltage. The chromaticity of the imitative natural light is matched with a sun-light trajectory on a color coordinate by adjusting the plurality of voltage difference between the first voltage, the second voltage and the third voltage.

Wherein, the illuminating apparatus further comprises a control module, and the control module is electrically connected to the first electrode, the second electrode and the third electrode, and can supply the first voltage, the second voltage and the third voltage to the first, second and third electrodes respectively, so as to control illuminating apparatus to emit the imitative natural light and adjust the color temperature, the brightness of the imitative natural light.

Wherein, the first organic light emitting diode and the second organic light emitting diode is a fluorescent material or a phosphorescence material.

Wherein, the first chromaticity and the second chromaticity comprises red light, blue light, green light, orange light, yellow light or white light.

Wherein, the plurality of voltage difference comprises a first voltage difference and a second voltage difference. The first voltage difference is the difference between the first voltage and the second voltage, and the second voltage difference is the difference between the second voltage and the third voltage. when the difference between the position of the imitative natural light on the color coordinate and the position of the first chromaticity on the color coordinate is smaller than the difference between the position of the imitative natural light on the color coordinate and the position of the second chromaticity on the color coordinate, the control module sets the first voltage difference larger than the second voltage difference.

Wherein, when the difference between the position of the imitative natural light on the color coordinate and the position of the first chromaticity on the color coordinate is larger than the difference between the position of the imitative natural light on the color coordinate and the position of the second chromaticity on the color coordinate, the control module sets the first voltage difference smaller than the second voltage difference.

Wherein, when the difference between the position of the imitative natural light on the color coordinate and the position of the first chromaticity on the color coordinate is equal to the difference between the position of the imitative natural light on the color coordinate and the position of the second chromaticity on the color coordinate, the control module sets the first voltage difference equal to the second voltage difference.

With the above arrangements, the illuminating apparatus and the illuminating method thereof according to the present invention has one or more of the following advantages:

(1) By providing different voltage to the illuminating apparatus, the OLED could emit light with several types of natural sunlight such as blue sky or sunset time, and thus further raise the practicability of the OLED.

(2) By integrating several sets of OLED on one illuminating apparatus, the color temperature and the brightness could be controlled freely and independently to increase the flexibility of using the illuminating apparatus.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a structure schematic diagram of an illuminating apparatus in accordance with one embodiment of the present invention;

FIG. 2 illustrates a schematic diagram of emitting light alone the sun-light trajectory on a color coordinate in accordance with one embodiment of the present invention;

FIG. 3 illustrates a flow chart of the illuminating method in accordance with the present invention; and

FIG. 4 illustrates a flow chart of adjusting the color temperature of the imitative natural light in accordance with the present invention.

### DETAILED DESCRIPTION

Exemplary embodiments of the present invention are described herein in the context of an illuminating system and a method thereof.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

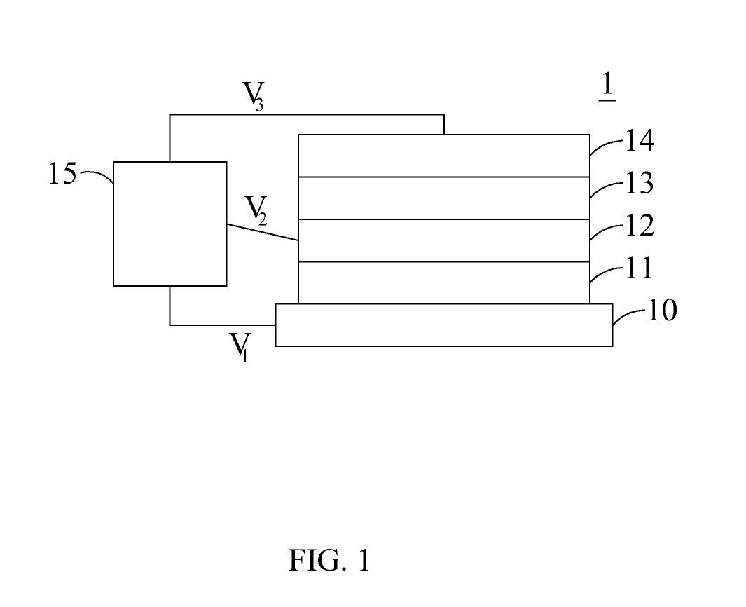

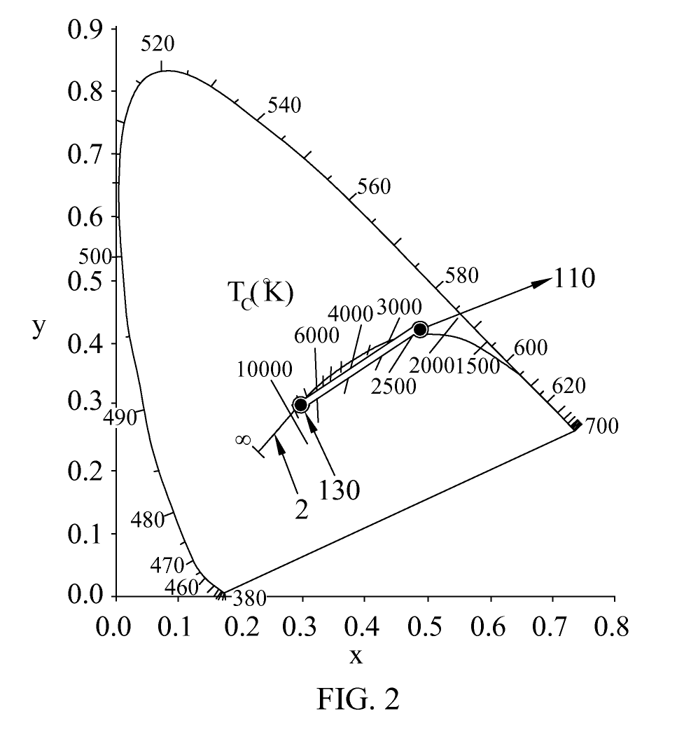

Please refer to FIG. 1, which illustrates a structure schematic diagram of an illuminating apparatus in accordance with one embodiment of the present invention. As shown in this figure, the illuminating apparatus 1 according to the present invention could be applied for emitting an imitative natural light, and comprises a first electrode 10, a first organic light emitting diode 11, a second electrode 12, a second organic light emitting diode 13 and a third electrode 14. The first organic light emitting diode 11 is disposed on the first electrode 10 and emitting lights with a first chromaticity 110; The second electrode 12 is disposed on the first organic light emitting diode 11; The second organic light emitting diode 13 is disposed on the second electrode 12 and emitting lights with a second chromaticity 130; The third electrode 14 is disposed on the second organic light emitting diode 13. The illuminating apparatus 1 further comprises a control module 15, and the control module 15 is electrically connected to the first electrode 10, the second electrode 12 and the third electrode 14, and can supply the first voltage V₁, the second voltage V₂ and the third voltage V₃ to the first, second and third electrodes 10, 12, 14 respectively, so as to control illuminating apparatus 1 to emit the imitative natural light and adjust the color temperature, the brightness of the imitative natural light. The chromaticity of the imitative natural light is matched with a sun-light trajectory on a color coordinate (as shown in FIG. 2) by adjusting a plurality of voltage difference between the first voltage V₁, the second voltage V₂ and the third voltage V₃. In addition, the first organic light emitting diode 11 and the second organic light emitting diode 13 could be a fluorescent material or a phosphorescence material.

Besides, the plurality of voltage difference includes a first voltage difference and a second voltage difference. The first voltage difference is the difference between the first voltage V₁ and the second voltage V₂, and the second voltage difference is the difference between the second voltage V₂ and the third voltage V₃. When the difference between the position of the imitative natural light on the color coordinate and the position of the first chromaticity 110 on the color coordinate is smaller than the difference between the position of the imitative natural light on the color coordinate and the position of the second chromaticity 130 on the color coordinate, the control module 15 sets the first voltage difference larger than the second voltage difference; on another hand, when the difference between the position of the imitative natural light on the color coordinate and the position of the first chromaticity 110 on the color coordinate is larger than the difference between the position of the imitative natural light on the color coordinate and the position of the second chromaticity 130 on the color coordinate, the control module 15 sets the first voltage difference smaller than the second voltage difference; on still another hand, when the difference between the position of the imitative natural light on the color coordinate and the position of the first chromaticity 110 on the color coordinate is equal to the difference between the position of the imitative natural light on the color coordinate and the position of the second chromaticity 130 on the color coordinate, the control module 15 sets the first voltage difference equal to the second voltage difference.

In one preferred embodiment, the first organic light emitting diode 11 emits warm white light, and this warm white light has the first chromaticity 110 (color temperature 2500K), and the second organic light emitting diode 13 emits cold white light, and this cold white light has the second chromaticity 130 (color temperature 8000K).

Meanwhile, if we need to emit a white light with the color temperature at 2500K, then the control module 15 could give the first voltage V₁, the second voltage V₂ and the third voltage V₃ to the first, second and third electrodes 10, 12, 14 respectively, and V₁=10V, V₂=0V and V₃=0V. Thus, the illuminating apparatus 1 would emit light with the color temperature at around 2500K. Simultaneously, if the illumination with lower brightness is preferred, then just adjust V₁ to 5V. Similarly, if V₁=0V, V₂=0V and V₃=−10V, then the illuminating apparatus 1 would emit the light with the color temperature at around 8000K. Simultaneously, if the illumination with lower brightness is preferred, then just adjust V₃ to −5V.

Therefore, if an imitative natural white light with the color temperature at around 4000K is preferred, the control module 15 could give the first voltage V₁, the second voltage V₂ and the third voltage V₃ to the first, second and third electrodes 10, 12, 14 respectively, and V₁=10V, V₂=5V and V₃=0V. Simultaneously, if in this embodiment the illumination with higher brightness is preferred, then the control module 15 adjusts V₁ to 20V and V₂ to 10V (twice of the original voltage).

Thus, the illuminating apparatus 1 in accordance with the present invention could emit light alone the sun-light trajectory on the color coordinate (as shown in FIG. 2) as illumination, and could simultaneously tune the brightness. In addition, the number of layers of the illuminating apparatus 1 in accordance with the present invention is not limited by two layers, but could be more than two layers; further, the chromaticity of the light emitted by the illuminating apparatus 1 comprises red light, blue light, green light, orange light, yellow light or white light. If the illuminating apparatus 1 having more than two layers OLED, then the moving trajectory on the color coordinate of the light emitted by the illuminating apparatus 1 will not be limited linear movement, but could move on a plane corresponding to the sun-light trajectory on the color coordinate.

The concept of the illuminating method in accordance to the present invention is simultaneously described in the description of the illuminating apparatus disclosed in the present invention, but in order to get clearer, the following will still illustrate the flow chart of the illuminating method

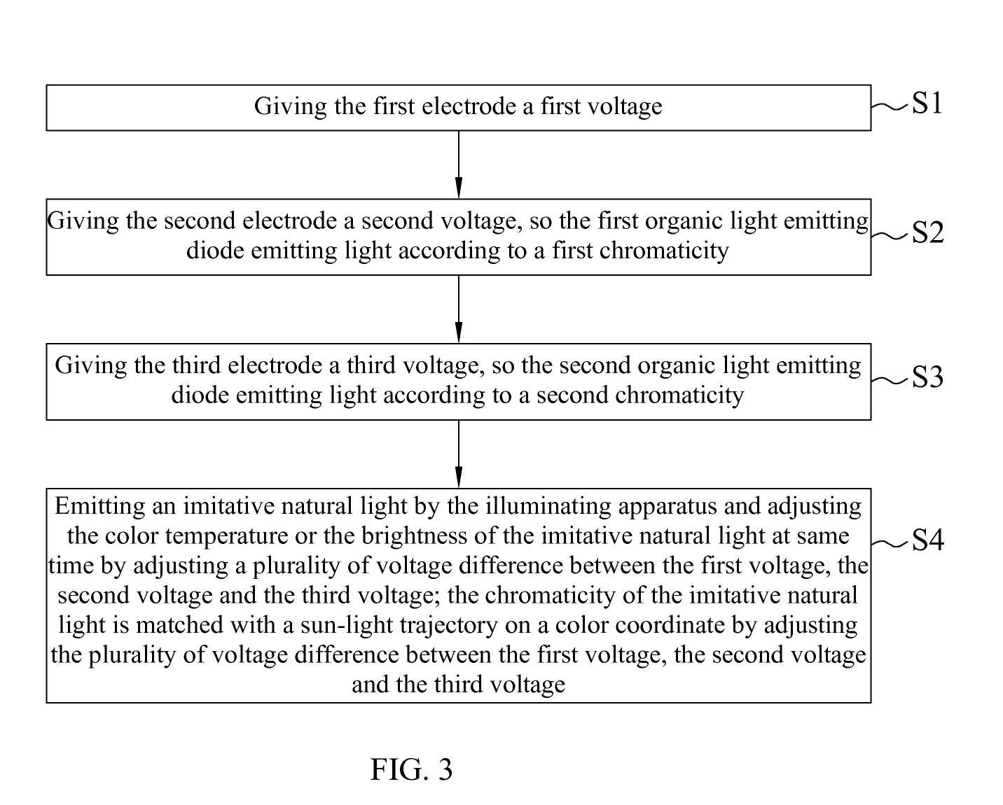

Please refer to FIG. 3, which illustrates a flow chart of the illuminating method in accordance with the present invention. As shown in this figure, the illuminating method according to the present invention is disclosed is applicable to an illuminating apparatus, and the illuminating apparatus could be a stack organic light emitting diode. The illuminating apparatus comprises at least a first electrode, a first organic light emitting diode, a second electrode, a second organic light emitting diode and a third electrode. The illuminating method comprises the following steps of:

(S1) giving the first electrode a first voltage;

(S2) giving the second electrode a second voltage, so the first organic light emitting diode emitting light according to a first chromaticity;

(S3) giving the third electrode a third voltage, so the second organic light emitting diode emitting light according to a second chromaticity; and

(S4) emitting an imitative natural light by the illuminating apparatus and adjusting the color temperature or the brightness of the imitative natural light at same time by adjusting a plurality of voltage difference between the first voltage, the second voltage and the third voltage; the chromaticity of the imitative natural light is matched with a sun-light trajectory on a color coordinate by adjusting the plurality of voltage difference between the first voltage, the second voltage and the third voltage.

By tuning the plurality if voltage difference between the first voltage, the second voltage and the third voltage, the chromaticity of imitative natural light could match with the sun-light trajectory on the color coordinate. The first organic light emitting diode and the second organic light emitting diode could be a fluorescent material or a phosphorescence material. Besides, the plurality of voltage difference includes a first voltage difference and a second voltage difference. The first voltage difference is the difference between the first voltage and the second voltage, and the second voltage difference is the difference between the second voltage and the third voltage.

Additionally, the illuminating apparatus further comprises a control module, and the control module is electrically connected to the first electrode, the second electrode and the third electrode, and can supply the first voltage, the second voltage and the third voltage to the first, second and third electrodes respectively, so as to control illuminating apparatus to emit the imitative natural light and adjust the color temperature, the brightness of the imitative natural light.

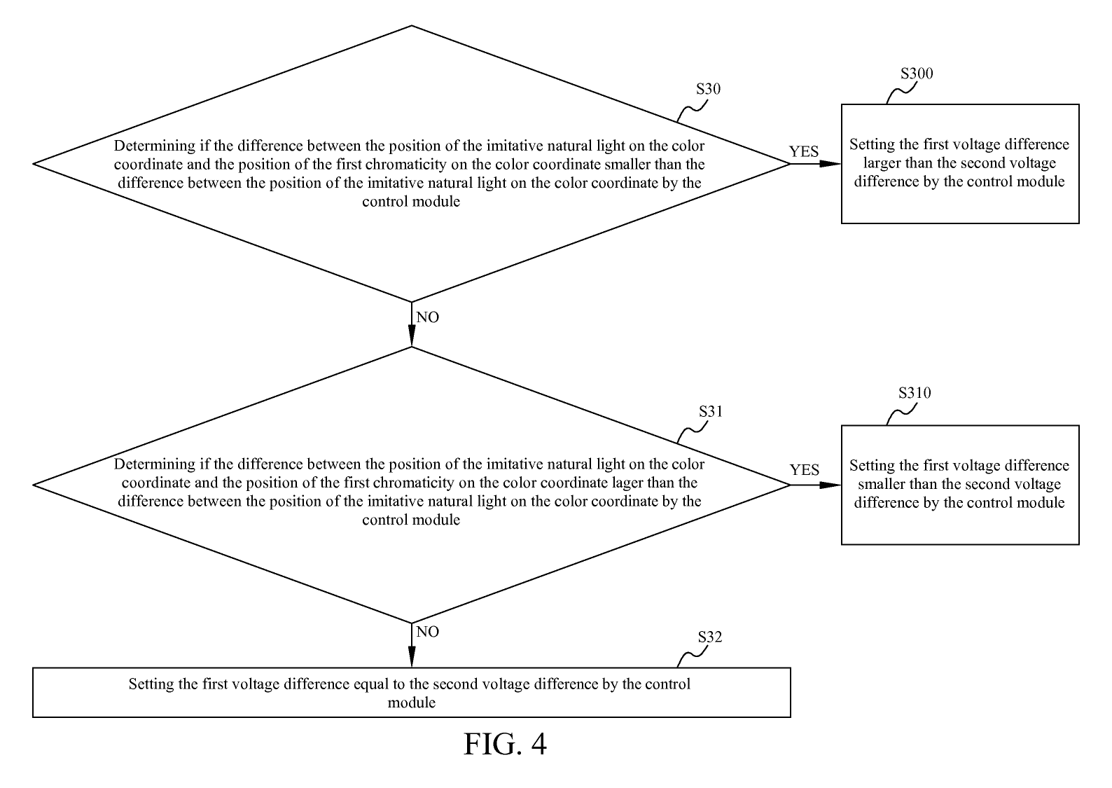

Please refer to FIG. 4, which illustrates a flow chart of adjusting the color temperature of the imitative natural light in accordance with the present invention. As shown in this figure, adjusting the color temperature of the imitative natural light comprises the following steps of:

(S30) determining if the difference between the position of the imitative natural light on the color coordinate and the position of the first chromaticity on the color coordinate smaller than the difference between the position of the imitative natural light on the color coordinate by the control module, if yes, go to step (S300), and if no, go to step (S31);

(S300) setting the first voltage difference larger than the second voltage difference by the control module;

(S31) determining if the difference between the position of the imitative natural light on the color coordinate and the position of the first chromaticity on the color coordinate lager than the difference between the position of the imitative natural light on the color coordinate by the control module, if yes, go to step (S310), and if no, go to step (S32);

(S310) setting the first voltage difference smaller than the second voltage difference by the control module; and

(S32) setting the first voltage difference equal to the second voltage difference by the control module.

The implementation of the illuminating method in accordance with the present invention has already described in the description of the embodiments of the illuminating apparatus according to the present invention, so it will not be stated here again.

In summary, the illuminating apparatus and the illuminating method thereof could emit light with several types of natural sunlight such as blue sky or sunset time by providing different voltage to the illuminating apparatus, so does increase the practicability of the OLED; the color temperature and the brightness of the light emitted by the illuminating apparatus could be controlled freely and independently, and so does increase the flexibility of using the illuminating apparatus.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. An illuminating apparatus, comprising:
a first electrode;
a first organic light emitting diode, disposed on the first electrode and emitting lights with a first chromaticity;
a second electrode, disposed on the first organic light emitting diode;
a second organic light emitting diode, disposed on the second electrode and emitting lights with a second chromaticity; and
a third electrode, disposed on the second organic light emitting diode;
wherein, the first electrode has a first voltage, the second electrode has a second voltage and the third electrode has a third voltage so the illuminating apparatus emits an imitative natural light; the chromaticity of the imitative natural light is matched with a sun-light trajectory on a color coordinate by adjusting a plurality of voltage difference between the first voltage, the second voltage and the third voltage.

2. The illuminating apparatus of claim 1, wherein the illuminating apparatus further comprises a control module, and the control module is electrically connected to the first electrode, the second electrode and the third electrode, and can supply the first voltage, the second voltage and the third voltage to the first, second and third electrodes respectively, so as to control illuminating apparatus to emit the imitative natural light and adjust the color temperature, the brightness of the imitative natural light.

3. The illuminating apparatus of claim 2, wherein the first organic light emitting diode and the second organic light emitting diode is a fluorescent material or a phosphorescence material.

4. The illuminating apparatus of claim 3, wherein the first chromaticity and the second chromaticity comprises red light, blue light, green light, orange light, yellow light or white light.

5. The illuminating apparatus of claim 4, wherein the plurality of voltage difference comprises:
a first voltage difference, which is the difference between the first voltage and the second voltage;
a second voltage difference, which is the difference between the second voltage and the third voltage;
when the difference between the position of the imitative natural light on the color coordinate and the position of the first chromaticity on the color coordinate is smaller than the difference between the position of the imitative natural light on the color coordinate and the position of the second chromaticity on the color coordinate, the control module sets the first voltage difference larger than the second voltage difference.

6. The illuminating apparatus of claim 5, wherein when the difference between the position of the imitative natural light on the color coordinate and the position of the first chromaticity on the color coordinate is larger than the difference between the position of the imitative natural light on the color coordinate and the position of the second chromaticity on the color coordinate, the control module sets the first voltage difference smaller than the second voltage difference.

7. The illuminating apparatus of claim 5, wherein when the difference between the position of the imitative natural light on the color coordinate and the position of the first chromaticity on the color coordinate is equal to the difference between the position of the imitative natural light on the color coordinate and the position of the second chromaticity on the color coordinate, the control module sets the first voltage difference equal to the second voltage difference.

8. An illuminating method, applicable to an illuminating apparatus, the illuminating apparatus comprising at least a first electrode, a first organic light emitting diode, a second electrode, a second organic light emitting diode and a third electrode, the illuminating method comprising the following steps of:
giving the first electrode a first voltage;
giving the second electrode a second voltage, so the first organic light emitting diode emitting light according to a first chromaticity;
giving the third electrode a third voltage, so the second organic light emitting diode emitting light according to a second chromaticity; and
emitting an imitative natural light by the illuminating apparatus and adjusting the color temperature or the brightness of the imitative natural light at same time by adjusting a plurality of voltage difference between the first voltage, the second voltage and the third voltage;
wherein, the chromaticity of the imitative natural light is matched with a sun-light trajectory on a color coordinate by adjusting the plurality of voltage difference between the first voltage, the second voltage and the third voltage.

9. The illuminating method of claim 8, wherein the illuminating apparatus further comprises a control module, and the control module is electrically connected to the first electrode, the second electrode and the third electrode, and can supply the first voltage, the second voltage and the third voltage to the first, second and third electrodes respectively, so as to control illuminating apparatus to emit the imitative natural light and adjust the color temperature, the brightness of the imitative natural light.

10. The illuminating method of claim 9, wherein the first organic light emitting diode and the second organic light emitting diode is a fluorescent material or a phosphorescence material.

11. The illuminating method of claim 10, wherein the first chromaticity and the second chromaticity comprises red light, blue light, green light, orange light, yellow light or white light.

12. The illuminating method of claim 11, wherein the plurality of voltage difference comprises:
a first voltage difference, which is the difference between the first voltage and the second voltage;
a second voltage difference, which is the difference between the second voltage and the third voltage;
when the difference between the position of the imitative natural light on the color coordinate and the position of the first chromaticity on the color coordinate is smaller than the difference between the position of the imitative natural light on the color coordinate and the position of the second chromaticity on the color coordinate, the control module sets the first voltage difference larger than the second voltage difference.

13. The illuminating method of claim 12, wherein when the difference between the position of the imitative natural light on the color coordinate and the position of the first chromaticity on the color coordinate is larger than the difference between the position of the imitative natural light on the color coordinate and the position of the second chromaticity on the color coordinate, the control module sets the first voltage difference smaller than the second voltage difference.

14. The illuminating method of claim 12, wherein when the difference between the position of the imitative natural light on the color coordinate and the position of the first chromaticity on the color coordinate is equal to the difference between the position of the imitative natural light on the color coordinate and the position of the second chromaticity on the color coordinate, the control module sets the first voltage difference equal to the second voltage difference.
